(19) United States
(12) Patent Application Publication
(10) Pub. No.: US 2009/0177678 A1
(43) Pub. Date: Jul. 9, 2009

(54) Locating Linear Reference System Events in a Geographic Information System

(75) Inventors: James B. Clark, Fairlee, VT (US); Brad Hibner, West Lebanon, NH (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/350,174

(22) Filed: Jan. 7, 2009

Related U.S. Application Data
(60) Provisional application No. 61/019,820, filed on Jan. 8, 2008.

(51) Int. Cl. G01C 21/36; G06F 17/30

(52) U.S. Cl. 707/101; 701/209; 707/102; 707/E17.005; 707/E17.009

(57) ABSTRACT

A method and system are provided for determining the geographic locations of events in a linear referencing system (LRS), such as a LRS for the Department of Transportation. The method and system utilize similarities between a LRS and the postal addressing system used in the United States. A LRS event geocoding database and schema are created from portions of the postal addressing system schema and geographic information system (GIS) schema. LRS data is encoded as postal address data as defined in the postal addressing system. The LRS data and GIS data are conflated to populate the LRS event geocoding database using similar transformation logic as for current postal address geocoding. The geographic location of a given LRS event is generated using geocoding software that utilizes the linear measure implicit in the LRS event identifier and the LRS event geocoding database.

### CLAIM OF PRIORITY

This application claims priority to U.S. Provisional Patent Application 61/019,820 filed Jan. 8, 2008, by James B. Clark and Brad Hibner, entitled “LOCATING LINEAR REFERENCE SYSTEM EVENTS IN A GEOGRAPHIC INFORMATION SYSTEM,” which is hereby incorporated by reference.

### BACKGROUND OF THE INVENTION

1. Field of the Invention

The invention is related to data transformation and, specifically, to a method and system for determining the correct representation of the geographic location of new events in a Linear Reference System (LRS).

2. Description of the Related Art

In mapping and related applications, the need regularly arises to combine Linear Reference System (LRS) data, in particular events of interest, with data obtained from Geographic Information Systems (GIS). A LRS is a system in which events of interest, such as data related to roads, railways, and rivers are localized by a measure along a linear element. Some examples of events of interest are a sign for a speed limit change or a callbox along the road, or data related to roads, railways, or rivers that intersect the road. Each event is localized by a point known as a mile point. The system is designed such that if a segment of a route is changed, only those mile points on the changed segment need to be updated. A GIS, on the other hand, is a system that includes geographic positions of the events of interest, as used in maps. Unfortunately, conflation of the two data sets is far from obvious. Further, complications can arise from the fact that GIS data uses planimetric measurements, whereas LRS data employs direct measurement of the distance between two points.

When the user of a LRS linked to a GIS receives positional updates to the GIS, the LRS must be updated to maintain the one-to-one linear mapping of events of interest to the corresponding geographic positions of those events. Otherwise, changes in the representation of position between two versions of a geographic database make LRS events appear to jump from one geographic position to another.

Geographic databases need to be updated on occasion for various reasons. For example, one reason might be due to improved measures of the locations of real world objects in the geographic database. Another reason might be due to changes in the transformation used to represent the ellipsoidal earth in a flat projection for improved display characteristics.

When new LRS events occur and need to be located in an associated GIS, currently available software for addressing this task is very expensive to purchase and is time-consuming and difficult to use. At least three different approaches have been tried. All of these methods start with direct measurements of the location of events in the field. This might involve surveying and/or GPS measurements to determine the exact location in the real world.

In one approach, event location is stored in tabular form or as an unstructured document and recalled manually for reference by a user, while the user views a geographic representation of an area of interest. The user visually and mentally transforms the tabular data to geographic location. In another approach, event location is stored using the annotation capability provided in Computer Aided Design software, often used as a GIS to position and store event location relative to surrounding control points. In another approach, event location is stored by performing segmentation of the GIS data, known as dynamic segmentation. This process recalculates the precise location of events by comparing real world measurements to GIS representations and interpolation. The preferred method is currently dynamic segmentation, when sufficient resources are available. Implementations of dynamic segmentation are typically centralized and require specialized software to interpolate and recalibrate the LRS events for the GIS.

Currently, the locations of events are typically stored as coordinate values that are properties of a specific LRS route, or in separate tables. For example, the goal of dynamic segmentation is to place a street segment node at each event. Many Departments of Transportation (DOTS) in the United States, including state and federal DOTs, as well as DOTs in other countries, are finding it useful to display visually the events in a LRS using a geographic database of street segments and other features to provide a map of the event locations. One cannot do this directly from the LRS table of events. In the LRS, the position of an event is given as the linear distance from the point of beginning of a route to the event along the route, which is not sufficient to be directly transformed into the geographic coordinates of a point aligned to a specific geographic database. Therefore, some method of aligning the LRS routes and events to the corresponding street segments in the geographic database is required.

The typical method, dynamic segmentation, registers the LRS route with the corresponding set of street segments in the geographic database, and then divides the segmentation of the streets so that there is a break in the segmentation, or node, at the locations of events in the LRS. The LRS events along a route thereby produce a new street segment database along with the locations of events as defined in the LRS. The process of dynamic segmentation is well documented, and there are commercial and public domain algorithms implemented. However, the process is complex, and there are various optimizations that trade off quality for time. Often the quality of the new street database and event locations cannot be determined until after the process is run and the results tested. It is very common to follow up dynamic segmentation with manual re-segmentation, sometimes extensive, to force events to their proper locations in the geographic database. Dynamic segmentation is intended to produce a new street database as well as geographic locations of events suitable for use with that new street database.

Each of the current approaches requires either manual field measurements or redundant processing of multiple data layers. What is needed is a better method and system for determining the correct representation of the geographic location of events in a Linear Reference System (LRS).

### SUMMARY OF THE INVENTION

A method and system are provided for determining the geographic locations of events in a linear referencing system (LRS), such as a LRS for the Department of Transportation. The method and system utilize similarities between a LRS and the postal addressing system used in the United States. A LRS event geocoding database and schema are created from portions of the postal addressing system schema and geographic information system (GIS) schema. LRS data is encoded as postal address data as defined in the postal addressing system. The LRS data and GIS data are conflated to populate the LRS event geocoding database using similar transformation logic as for current postal address geocoding. The geographic location of a given LRS event is generated using geocoding software that utilizes the linear measure implicit in the LRS event identifier and the LRS event geocoding database.

### BRIEF DESCRIPTION OF THE DRAWINGS

Further details of the present invention are explained with the help of the attached drawings in which:

FIG. 1 illustrates records of an example postal addressing system database, according to embodiments of the present invention;

FIG. 2 illustrates an example map overlaid with information from the postal addressing information shown in FIG. 1, according to embodiments of the present invention;

FIG. 3 illustrates street records of an example geographic information system (GIS) database, according to embodiments of the present invention;

FIG. 4 illustrates example records of a resulting postal address geocoding database constructed from the example postal addressing system database records illustrated in FIG. 1 and the example GIS database records illustrated FIG. 3, according to embodiments of the present invention;

FIG. 5 illustrates an example flowchart of the postal address geocoding process, according to embodiments of the present invention;

FIG. 6 illustrates an example flowchart of the postal address reverse geocoding process, according to embodiments of the present invention;

FIG. 7A illustrates records of an example LRS event table containing typical events of interest, according to embodiments of the present invention;

FIG. 7B illustrates a top view of the actual route and various event locations described in FIG. 7A, according to embodiments of the present invention;

FIG. 8 illustrates an example postal addressing system street segment and an example LRS route that show similarities between the two systems, according to embodiments of the present invention;

FIG. 9 illustrates potential addresses accounting for roadbed elevation, according to embodiments of the present invention;

FIG. 10A illustrates an example LRS route definition table for the route illustrated in FIG. 7A, according to embodiments of the present invention;

FIG. 10B illustrates an example postal address geocoding table entry, according to embodiments of the present invention;

FIG. 10C illustrates an example LRS route of FIG. 10A formatted and mapped to the postal address geocoding database format of FIG. 10B, according to the present invention;

FIG. 11A illustrates an example alignment of postal address data in FIG. 10B with a geographic database, according to embodiments of the present invention;

FIG. 11B illustrates an example alignment of LRS data in FIG. 10C with a geographic database, according to embodiments of the present invention;

FIG. 12 illustrates an example LRS route definition table for the area identified in the postal addressing system table of FIG. 1, according to embodiments of the present invention;

FIG. 13 illustrates an example map overlaid with information from the LRS route definition table shown in FIG. 12, according to embodiments of the present invention;

FIG. 14 illustrates example records of a resulting LRS event geocoding database constructed from the example LRS route definition table records illustrated in FIG. 12 and the example GIS database records illustrated in FIG. 3, according to embodiments of the present invention;

FIG. 15 illustrates an example flowchart of the LRS event geocoding process, according to embodiments of the present invention;

FIG. 16 illustrates an example flowchart of the LRS event reverse geocoding process, according to embodiments of the present invention; and

FIG. 17 shows a block diagram of an exemplary system 1700 that can be used with embodiments of the invention.

### DETAILED DESCRIPTION OF THE INVENTION

Generally described, a method and system are provided for determining the geographic locations of events in a Department of Transportation (DOT) Linear Reference System (LRS). That is, a DOT can use this method and system to find where a particular LRS event is located on the face of the earth, for example, to dispatch a maintenance crew. This method and system can be useful for representing LRS events in a geographic database used by a geographic information system (GIS) to display, map, and analyze spatial information.

LRS data is conflated with GIS data for use in electronic maps and electronic databases. A LRS event geocoding database is created and geocoding software is used to generate the location of an event from the linear measure implicit in an event identifier. The event identifier, description, and location are subsequently inserted into the appropriate layer of a pre-existing and unmodified geographic database for mapping and display. The geocoding database must incorporate the same street segment database as the DOT uses to display the event locations. This method and system are used to provide geographic locations for new events and to relocate events when the associated GIS database changes.

The method and system are automated and utilize similarities between LRS and the postal addressing system used in the United States. The same underlying two-dimensional street geography data as postal address geocoding is used, and the same transformational logic as postal address geocoding is used. The type of data used, for example postal or DOT, then determines what input data can be transformed.

An address coding guide, which is a software utility, allows the user to enter the LRS-based event location and receive the correct two-dimensional location for that event with respect to a specific version of the geographic database in use by the GIS. When a new geographic database is issued for the GIS, a matching version of the LRS-based geocoding database is also issued. Events of interest are located in each version of the GIS database using LRS-based geocoding to get the coordinates of the event as represented in the GIS. In this manner, whole-scale realignment of all LRS events to a new version of a geographic database is provided, as well as determination of new event locations in the associated geographic database.

Event locations are treated as attributes of the individual street segments, as represented in the GIS, thus avoiding the significant cost of dynamic segmentation. Time and resources to re-create a new geographic database are not required, as in dynamic segmentation, and the event locations produced are immediately applicable to an existing geographic database. Redistribution of segment end points or nodes in the street network represented in the GIS is not needed. Furthermore, an immediate location is provided for new events as they arise, and these can be added to the geographic database without disrupting other users and uses of that geographic database. The amount of manual work is significantly reduced if not completely eliminated compared to dynamic segmentation.

Furthermore, when new LRS events occur and need to be located in the associated GIS, an immediate answer is produced without field measurement, modification of, or reference to the GIS database. Thus, a user is enabled to locate potentially, and not limited to, two to three million objects in an hour, not including hand corrections.

Linear References are linear representations of continuous paths or routes over existing roadways. These existing roadways are also represented in an associated geographic (GIS) database. These linear routes are defined by the end user for his own application purposes. One goal is to keep track of the real-world event locations as represented in successive versions of geographic databases.

An address geocoder is a database and associated search engine that converts postal address information into the geographic location of that address in a geographic database. The address geocoding database is specifically designed to permit very fast conversion from the linear along-the-street postal address identifier to the corresponding two-dimensional geographic coordinate. In the address geocoding database, each roadway is conceptually mapped to a control section of a continuous linear route with a unique name and potential address ranges assigned to intervals along the control section of the route.

Postal address roadway routes are replaced with arbitrarily defined Linear Reference routes, each having equally spaced “addresses” defined along it. The LRS defines these as independent routes, each with a point of beginning and a point of ending. Unlike postal addresses, each route may cover sections of roadways with different names, the only requirement being that the route is continuous from beginning to end.

If a new user has an existing GIS database and associated LRS routes, an initial calibration and alignment process must be completed for migration from the pre-existing GIS database to the new GIS database. Once completed, realignment of the LRS-based geocoding and the GIS database is performed automatically with each new release of the GIS database. The re-calibration of the LRS-based geocoding may be performed by the GIS database vendor by comparing the locations of control points in the previous and next GIS databases.

The identification of the location of each event is maintained by geocoding the existing events each time a new GIS database is received. Geocoding can locate events at rates in excess of millions per day, orders of magnitude faster than prior methods. In the same manner, new events can be located in the GIS by geocoding the “address” of the new event.

In order to understand the construction, operation, and application of the invention more clearly, it will first be compared to a system for postal address geocoding.

### Postal Addressing System

A postal addressing system is provided which is very similar to that used by the United States Postal Service in many jurisdictions. A postal addressing system is applied to a street network by assigning a set of numeric values to structures on streets. Typically these addresses run in numeric sequences with the “even” numbers on one side of a street and the “odd” numbers on the opposite side of the street. In digital street mapping, these numbers are applied to segmented lines, or segments, in generally consistent directions. Each address in the postal addressing system can be thought of as a unique combination of jurisdiction name, postal code, street name, and address number. A jurisdiction name is a locality name, such as the name of a county, city, or any other legally defined area of geography. The postal addressing system can be thought of as a range of addresses running on the left and right sides of the street From one point To another. These ranges are often abbreviated LFrom, LTo (Left from and Left to), RFrom and RTo (Right from and Right to). In this system, address ranges may start at the intersection of a street with another street, or a point of local historic significance and extend in both directions to the full extent of the named addressed street in a single jurisdiction. Address ranges, or a range of address numbers, are assigned to both sides of the street. An address range usually encompasses address numbers on one side of a street between intersecting streets. Thus, between two intersecting streets, there will be two address ranges, one for each side of the street. Each address range usually has odd address numbers on one side of the street and even address numbers on the other side of the street, usually at the rate of one hundred addresses per address range.

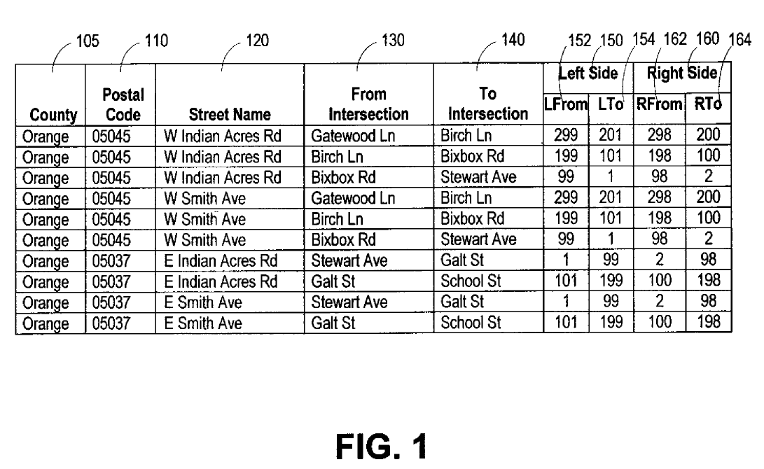

FIG. 1 illustrates records of an example postal addressing system database, according to embodiments of the present invention. This addressing scheme is applied to several sections of streets within the jurisdiction of Orange County 105 and for postal codes 110, which are 05045 and 05037 in this example. The postal addressing scheme is, in itself, a tabular system without a geographic reference. That is, the system does not record or depend on the geographic location of the streets, other than as sequential markers along the full extent of any street. Furthermore, there is no explicit declaration of the geographic extent, or the boundaries, of the 05045 or 05037 postal codes. The boundaries are implicit in the list of streets and address ranges defining it.

For example, street names are shown in the street name column 120. The streets have limits defined by identifiable landmarks, such as cross streets. The streets are broken into street segments, usually between two intersections, for example, between From intersection column 130 and To intersection column 140. Between From intersection 130 and To intersection 140 is the Left side 150 of the street, which forms an address range bounded by LFrom column 152 and LTo column 154. Between From intersection 130 and To intersection 140 is the Right side 160 of the street, which forms an address range bounded by RFrom column 162 and RTo column 164. Taking the first row, for example, street name “W. Indian Acres Rd.” from intersection Gatewood Ln. to Birch Ln., the address range on the left side of W. Indian Acres Rd. is a range of odd numbers from 299 to 201, and the address range on the right side of W. Indian Acres Rd. is a range of even numbers from 298 to 200. In embodiments, some or all of the address numbers on one street side can be even numbers, and some or all of the address numbers on the other street side can be odd numbers. In embodiments, From intersection and To intersection columns 130 and 140 can be landmarks other than intersections.

Assume the following characteristics of the postal addressing system:

1) Address ranges are applied to street segments such that all even numbered addresses are on one side, and all odd numbered addresses are on the other.

2) A street segment is a continuous length of roadway between two intersecting roadways, intersecting and terminating roadways, or between an intersecting or terminating roadway and the termination, such as a dead end or cul de sac, of the street.

3) A full street name includes up to four parts. These four parts are the direction prefix, the base name, the roadway type designation, and direction suffix. For all street naming systems, the base name is always required to exist. Examples of direction prefix and suffix are north, south, east, and west, among others. An example of the basename is Main in Main St. Examples of the roadway type designation are, among others, Street, Avenue and Boulevard or their abbreviations St., Ave., and Blvd.

4) A full street name is continuous along the entire length of a segment.

5) Any combination of jurisdiction name, postal code, street name, and address number must be, and is, unique. There is only one location having that address. A valid, complete postal address for geocoding contains the jurisdiction name, postal code, street name, and address number for an actual address. Although county 105 is used in the figures, the more general term is jurisdiction name, as discussed above. The postal code can sometimes be used without other unambiguous identifiers such as a jurisdiction name.

A real postal addressing system has to deal with many exceptions to these characteristics, but the exceptions are well known and understood by those of ordinary skill in the arts of databases and map making. For example, there are usually far less than one hundred addressable land parcels along both sides of a single street segment. Therefore, an address range usually encompasses more potential addresses than could possibly physically exist on a street segment. A real postal addressing system would address how to distribute individual addresses within the range along an individual segment. In some cases, addresses are distributed evenly across the range from one end to the other, skipping potential addresses between real addresses. In other cases, addresses may be issued consecutively on both sides, so that only the lower end of the range is ever assigned to real addresses.

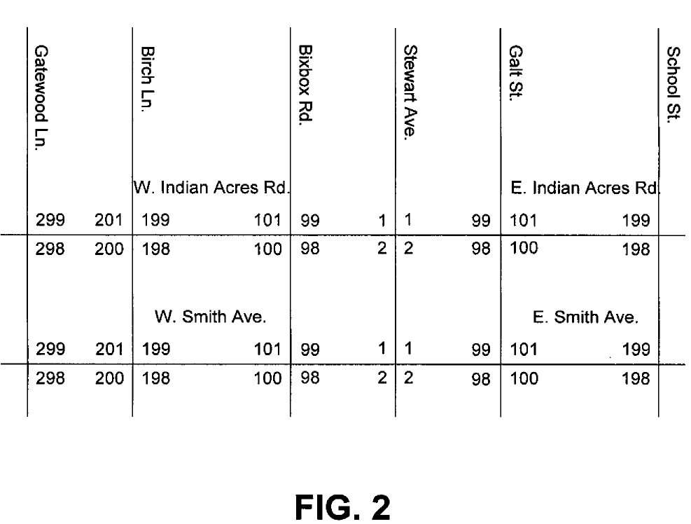

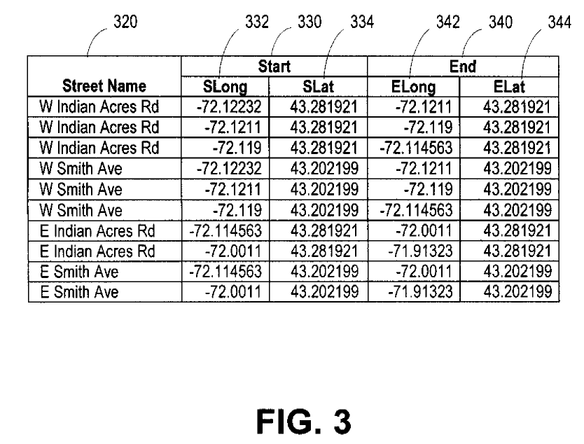

FIG. 2 illustrates an example map overlaid with information from the postal addressing information shown in FIG. 1, according to embodiments of the present invention. This map, or cartographic representation, is an example of what the streets of FIG. 1 might look like. Overlying the map is postal addressing system information from FIG. 1, such as address range numbers. Note that in this simplified map, the streets are represented as straight lines formed by connecting the geographic coordinates of street intersections. Though the drawing part of the map is simplified, the actual coordinates of the points of intersection are precisely known. The kind of map overlay shown in FIG. 2 is typically produced from the database of a geographic information system (GIS), the details of which are discussed further in relation to FIG. 3.

### Geographic Information System

A Geographic Information System (GIS) is a system for capturing, storing, analyzing, and managing data and associated attributes, which are spatially referenced to the earth. For example, a GIS stores locations of street intersections and street end points. Location always refers to a geographic location, the coordinates of a point on the surface of the earth, such as latitude and longitude. A postal address is not a location, but it is a reference to a location. Without more information, such as a geographic reference, one cannot navigate to an arbitrary address. If nothing else, unless one already happens to be on the correct street, one would not be able to tell where to go simply by studying the arbitrary address. Thus, once a geographic reference system is attached to a postal address system, addresses can be directly converted into a location by the process of geocoding. Details of geocoding are discussed below, but first, example database records of a GIS are shown in FIG. 3.

FIG. 3 illustrates street records of an example geographic information system database, according to embodiments of the present invention. In this simplified GIS example, street segments from FIG. 1 are used. Each street segment is listed by a street name, as well as by the latitude and longitude coordinates of the ends of the street segments. For example, the street name of the street segment is shown in the street name column 320. Each street segment has a Start 330 end point and an End 340 end point. Each Start 330 end point is identified by longitude and latitude, shown in the SLong column 332 and SLat column 334, respectively. End 340 end point is identified by longitude and latitude, shown in the ELong column 342 and ELat column 344, respectively. As shown in the first three rows, in the street name column 320, W. Indian Acres Rd. has been divided into three street segments. As shown in SLat column 334 and ELat column 344, the latitude for each of the three street segments is 43.281921, so the street runs east-west along the same latitude. The first street segment longitude runs from −72.12232 in SLong column 332 to −72.1211 in ELong column 342. The second street segment longitude runs from −72.1211 in SLong column 332 to −72.119 in ELong column 342. The third street segment longitude runs from −72.119 in SLong column 332 to −72.114563 in ELong column 342. These three street segments, end-to-end at their end point longitudes, together form the length of W. Indian Acres Rd.

### Postal Address Geocoding Database

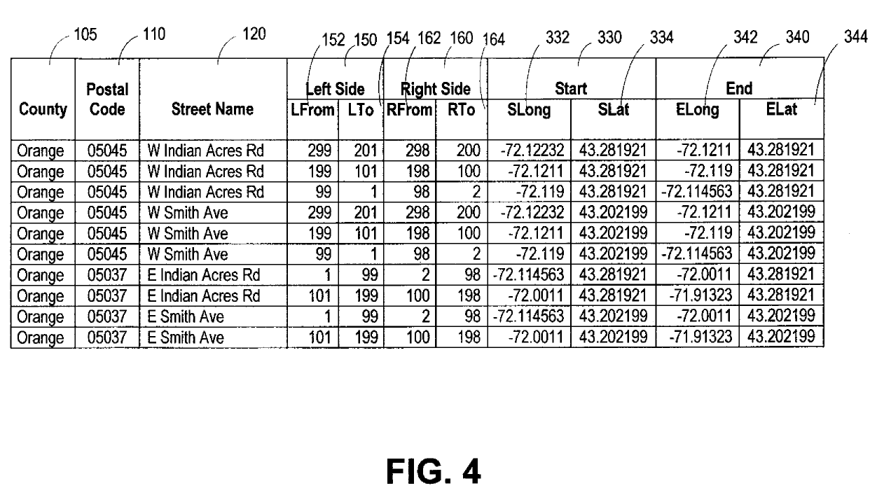

A postal address geocoding database can be constructed by combining the postal addressing system database and the Geographic Information System (GIS) database. Additionally, an address coding guide is an implementation of a postal address geocoding database. A postal address geocoding database is desirable in order to be able to translate between postal addressing and locations, as referenced in a GIS. The basic approach is to form a database by matching postal and geographic points, such as street intersections. For example, the end points of a geographic segment from the GIS database are matched with lower and upper limits of an address range from the postal addressing system for the geographic segment. This process “geo-references” the addresses, making geocoding possible. FIG. 4 illustrates example records of a resulting postal address geocoding database constructed from the example postal addressing system database records illustrated in FIG. 1 and the example GIS database records illustrated FIG. 3, according to embodiments of the present invention. For convenience, elements carried over from FIGS. 1 and 3 are similarly labeled.

A key component of building a geocoding database is the correct matching of specific cross-streets in the postal addressing system database to the appropriate segment and segment ends in the GIS database. This process of identifying, matching, and then combining the data from two different databases is called conflation. There are many conflation methods and techniques available which trade off speed, accuracy, size, and quality affecting both the building process resources required and the qualities of the geocoding database built.

To describe FIG. 4 a bit further, the conflation process is used to find rows in FIGS. 1 and 3 that correspond to each other. Although details of the conflation process will not be discussed in more detail here, one part of the conflation process for this example is to find rows in FIGS. 1 and 3 that have the same street name. For example, both FIGS. 1 and 3 contain three rows having the street name, W. Indian Acres Rd. In embodiments, through a more detailed conflation process that will include such items as identifying cross street attributes from the more detailed actual GIS database, and not the example GIS database of FIG. 3, the process will find that the street segment in the first row of FIG. 1 corresponds to the street segment in the first row of FIG. 3. A combination of these two rows provides the first row of FIG. 4. The following FIG. 4 columns county 105, postal code 110, street name 120, Left side 150, LFrom 152, LTo 154, Right side 160, RFrom 162, and RTo 164 correspond to the same FIG. 1 columns. Similarly, the following FIG. 4 columns Start 330 end point of a street segment, SLong 332, SLat 334, End 340 end point of the street segment, ELong 342, and ELat 344 correspond to the same FIG. 3 columns.

For each record in one or more of the GIS database and the postal address geocoding database, the representation of a street segment can include additional breaks in the segmentation between intersections to provide a truer representation of the actual path of the street centerline over the earth. The assumption is that the truer the path, the more accurately placed the geocode. The more spatially accurate the geocode, the higher value the result. Parametric representations of street curves and lines, while a little more difficult to manage, can also be used in place of simple coordinate points connected by straight lines.

Additional information can be collected to improve the alignment of the addressing and geographic information systems. For example, the actual address range can be obtained and substituted for the potential address range in one or more of the postal addressing system database and the postal address geocoding database. The actual physical addresses can also be collected and used in place of address ranges.

Street addressing exceptions can be provided for in various ways. For example, the locations of so-called “vanity addresses,” which are single point addresses along a segment that do not conform to the system-assigned addressing range or street name, can each be measured and represented as a single-sided, unit-range, vanity address record in the databases.

### Postal Address Geocoding Process

Now that the process of building a postal address geocoding database has been explained, the process for using the postal address geocoding database to convert a postal address to a geographic location will be described. The process of transforming the unique combination of jurisdiction name, postal code, street name, and address number into the geographic coordinates of the point location is called geocoding. Similarly, the reverse logic can convert a location into an address by the process of “reverse geocoding.”

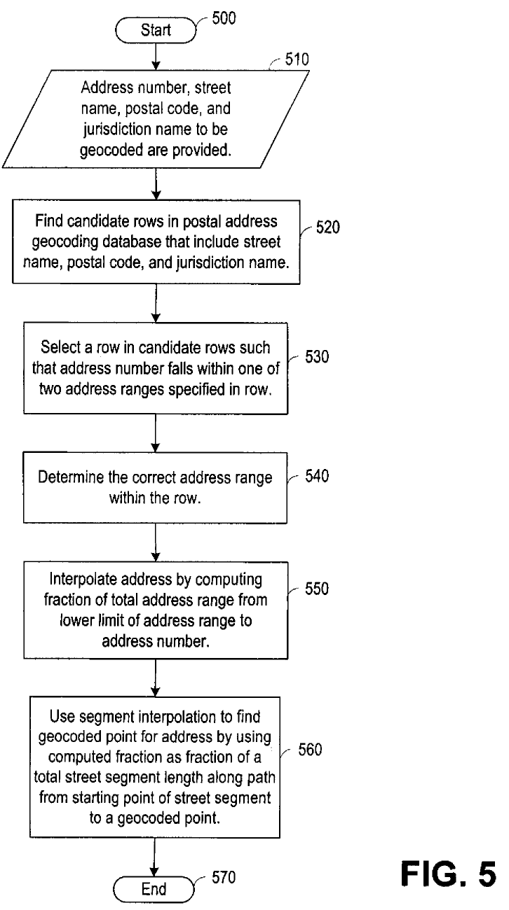

FIG. 5 illustrates an example flowchart of the postal address geocoding process, according to embodiments of the present invention. The process begins in step 500. In step 510, a combination of address number, street name, postal code, and jurisdiction name is provided to the process. This unique combination is the address to be geocoded. At least three assumptions will be made for purposes of this illustration. First, it is assumed for geocoding purposes that this address is valid and complete. Second, an even distribution of address numbers within the stated range along the entire street segment length is assumed. Third, it is assumed that for the resulting geocoded location, the offset from the street segment to one side or to the other of the street segment is arbitrarily applied, as an address is generally at an offset from the street.

While real postal address geocoding is often more detailed, the basic approach is always the same. Exceptions to the basic approach exist, and these exceptions are handled. For example, one exception involves even/odd numbering that is assigned differently than the regular plan, for example, when the numbering, or parity, on one street block is backward. Another exception occurs when features are clustered at one end or the other of a segment, which can happen if a street segment is long with very few structures. Other exceptions are applying an appropriate offset to the correct side of the street centerline, handling missing, incorrect, incomplete, or ambiguous address information, dealing with an addressing system that is more chaotic and/or alphanumeric, and rectangular grid systems that have no plan.

In step 520, candidate rows in the postal address geocoding database that include the street name, postal code, and jurisdiction name are found. In step 530, a row is selected from the candidate rows found in step 520, such that the address number being geocoded falls within an address range specified in the row. These two address ranges in the selected row of the postal address geocoding database of FIG. 4 came from the postal addressing system database of FIG. 1. The two address ranges are for address on each side of the street segment. In step 540, the correct address range within the row is determined. For an address number being geocoded that is an odd number, the range limits determined from the row are the odd number range limits, and correspond to either the left side or the right side of the street. Likewise, for an address number being geocoded that is an even number, the range limits determined from the row are the even number range limits, and correspond to the opposite side of the street to which the odd number range limits correspond.

In step 550, address interpolation is performed by computing the fraction of that total address range in the selected row of step 530 that is represented by the amount from the lower limit of the address range to the address number being geocoded. This step can be performed by the following substeps:

1) subtracting the lower limit of the address range from the address number,

2) subtracting the lower limit of the range from the upper limit of the range, and

3) dividing the result in 1) by the result in 2).

In step 560, segment interpolation is performed to find a geocoded point for the combination of address number, street name, postal code, and jurisdiction name using the fraction calculated in step 550. For the street segment specified in the selected row, this fraction is used to find the geocoded point as the fraction in length of the total street segment length along a path from the starting point of the segment to the geocoded point. The street segment and associated starting point in the row of the postal address geocoding database of FIG. 4 came from the GIS database of FIG. 3. This step can be performed by the following substeps:

1) determining the length of the street segment. This is the length of the path following any intermediate points, or vertices, used to define a windy path, if any. Information about these intermediate points is contained in geographic datum in the row of the database. In the case of the embodiment that takes into account the distortion of hills, the length of the path is appropriately scaled.

2) calculating a distance to the address using address numbers along the street segment to the address by multiplying the fraction obtained in step 550 by the length of the street segment obtained in 1).

3) starting at the LFrom or RFrom point of the street segment, measure the distance calculated in 2) along the path joining the start and end points of the street segment.

4) optionally, applying a small lateral shift to the left or right of the segment to place the address location on the correct side of the street segment and thereby finding the location of the address. For the example address ranges in FIG. 4, for all rows, the address ranges for the left side of the street with respect to the to-from direction are odd numbers, and the address ranges for the right side of the street are even numbers. If a street number is odd numbered, the address location will be shifted to the left side of the street, and if the street number is even numbered, the address location will be shifted to the right side of the street.

The process ends in step 570.

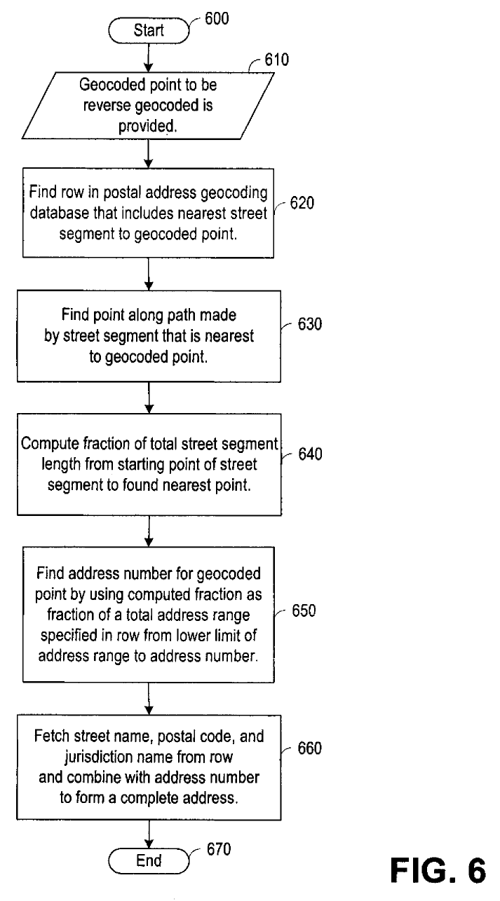

FIG. 6 illustrates an example flowchart of the postal address reverse geocoding process, according to embodiments of the present invention. Once the postal address geocoding database and geocoding logic are functioning properly, the same database and the reverse logic can be used to “reverse geocode.” That is, given a geographic location, the nearest street address to that location can be determined.

The process begins in step 600. In step 610, a geocoded point is provided to the process. This geocoded point will be reverse-geocoded, and is the point for which an address will be found. In step 620, the row that includes the nearest street segment to the geocoded point is found in the postal address geocoding database. This street segment in the postal address geocoding database of FIG. 4 came from the GIS database of FIG. 3. In step 630, the point along the path made by the street segment found in step 620 that is nearest to the geocoded point is found. A small lateral shift to the left or right of the segment can optionally be applied to the point along the path found in step 630. For purposes of determining the address, this shift will account for the address location on one side of the street that may be nearest to the geocoded point.

In step 640, the fraction of the total path length is computed by using the path length from the starting point of the street segment found in step 620 to the nearest point found in step 630, divided by the total path length of the street segment. In step 650, an address number corresponding to the geocoded point is found by using the fraction computed in step 640. For an address range specified in the row, this fraction is used to find the address number as a fraction of the total address range from the lower limit of the address range to an address number that will yield this fraction. The address range and associated lower limit of the address range in the row of the postal address geocoding database of FIG. 4 came from the postal addressing system database of FIG. 1. In step 660, the street name, postal code, and jurisdiction name from the row are fetched, and combined with the address number found in step 650 to form the complete address. The process ends in step 670.

A proprietary full-featured postal address geocoding system contains two basic components: 1) a postal addressing system database combined with a geographic information system database called a postal address geocoding database, and 2) a geocoding engine implementing the logic required to look up an address in the postal address geocoding database and interpolate its geographic location from the information provided by the database. It also provides more advanced capability, such as correcting common misspellings, handling incomplete or incorrect input, user selection of matching inferencing options, normalization of name spelling and postal codes, and reverse geocoding.

### Linear Referencing System

Linear referencing systems are used to record the locations of points of interest, called events, along their respective routes. LRSs have been historically used by State Departments of Transportation (DOT). The precise locations of these events, with respect to the point of beginning of the road segment, have been accurately measured by the DOT. The LRS includes two logical components, a table of route definitions, and a table of events. Depending on the implementation, these two tables may be combined into one, but they should be conceptualized as separate components of a LRS. In a LRS, the location of an event is completely described by a route and distance from the point of beginning of the route to the event.

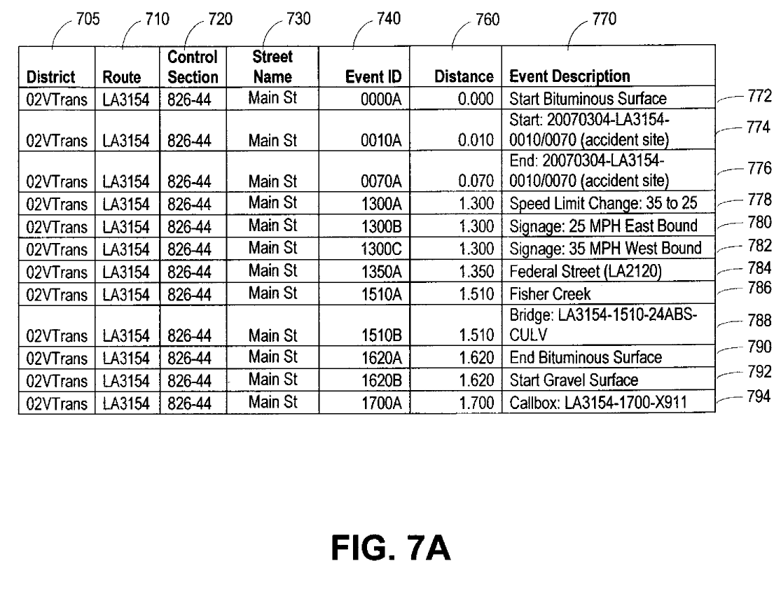

FIG. 7A illustrates records of an example LRS event table containing typical events of interest, according to embodiments of the present invention. The LRS event table is part of the LRS database. FIG. 7B illustrates a top view of the actual route and various event locations described in FIG. 7A, according to embodiments of the present invention. The design of a LRS is hierarchical, such that each event is typically associated with a nation, state, county, district, route, control section, and location. The hierarchy is not the same in all areas, however. For example, sometimes a route is not unique to a state. Whatever the hierarchy may be in a given area, event locations can still be stored in the LRS table using this hierarchy. An event is not necessarily unique but is associated with at least an event identification number and an event description. In FIG. 7A, each particular event is specified, with an increasing degree of specificity, by nation, state, and county, which are not shown, as well as district 705, route 710, and control section 720. Also associated with an event are the street name 730 at that particular point along the route, and an event ID number 740. A distance 760 is the distance of the event from the point of beginning of the route. In embodiments, the distance can be measured in units of miles. In embodiments, the distance can be measured in any type of units or combination of units, such as miles and feet. In embodiments, the event ID 740 is the combination of distance 760 without decimal points followed by a letter. The event IDs of two or more events occurring at a particular distance are distinguished by different ending letters.

Each event ID 740 identifies each event, such as those shown under event description 770. The distance of each of these events along Main St. is shown by their respective distances in distance column 760. Example of events include a change in speed limit “Speed Limit Change: 35 to 25” 778 and two specific road signs “Signage: 25 MPH East Bound” 780 located on one side of the road and “Signage: 35 MPH West Bound” 782 located on the opposite side of the road. These three events are at the same distance 1.300, and their event IDs are distinguished by their ending letters, as shown by 1300A, 1300B, and 1300C, respectively. Federal Street 784 is at distance 1.350, Fisher Creek 786 and a bridge 788 over Fisher Creek are at distance 1.510, and a specific callbox 794 is at distance 1.700.

In another example, two events 792 and 794 identify extended events or “points” of interest, like surface type. These points are the starting point and the ending point of the surface type, including “Start Bituminous Surface” 772 and “End Bituminous Surface” 790 at distances 0.000 and 1.620, respectively. Another example of extended points of interest is an accident site along the route, such as a car accident, between Start 774 and End 776, at distances 0.010 and 0.070, respectively. At distance 1.620 are two events. One is the end of one type of road surface “End Bituminous Surface” 790 and the other is the start of another type of road surface “Start Gravel Surface” 792. Other types of events include, but are not limited to, culverts, downspouts, paint striping, mile markers, and guardrails.

In a simple LRS, a path or route is a continuous length of roadway between two arbitrary points. These points are the point of beginning and point of ending for the route. Thus, a route has an accurately measured length assigned to it. A route has a system-wide unique identifier and its length can cover short stretches of many different named roadways, or can be confined to a limited stretch of a longer roadway with one name. Sometimes a roadway can be defined by two routes. For example, an east-west highway can be defined by an east route and a west route, or the east-west highway can be defined by one route. The routes are arbitrarily defined.

Using route/post/offset (RPO) notation, a location of interest, or an event, along a route is addressed by the following steps. For a route identifier (route), one would travel from the beginning of the route along the route toward the end. The last very accurately located mile marker post identifier (post) before reaching the event is noted. The distance from the point of beginning of the route to the event in feet is then determined in order to determine the number of feet beyond the post the event is located. For example, event 45.23.3121 is located on route 45, 23 miles and 3121 feet beyond the point of beginning of route 45.

The DOT uses a LRS to keep track of events. The distances of events enable the DOT to send employees to perform maintenance of a guardrail at a particular event distance, for example. The DOT can maintain call boxes, and know where to start and stop repaving the surface on the road. The DOT employee would go to the actual road to the point of beginning, then measure the distance of the event from the point of beginning, as discussed above. In practice, the employee can use mile markers or other uniquely identified events along the roadway to simplify the calculation of event distance. For the new surface example, the employee would need to measure the event distances for both the start surface type event and for the stop surface type event. The employee could use his or her Global Positioning System (GPS) or Geographic Information System (GIS) to perform this calculation as well. The police reports use LRS values to give distances of various events.

### Determining Similarities Between Postal Addressing System and Linear Referencing System

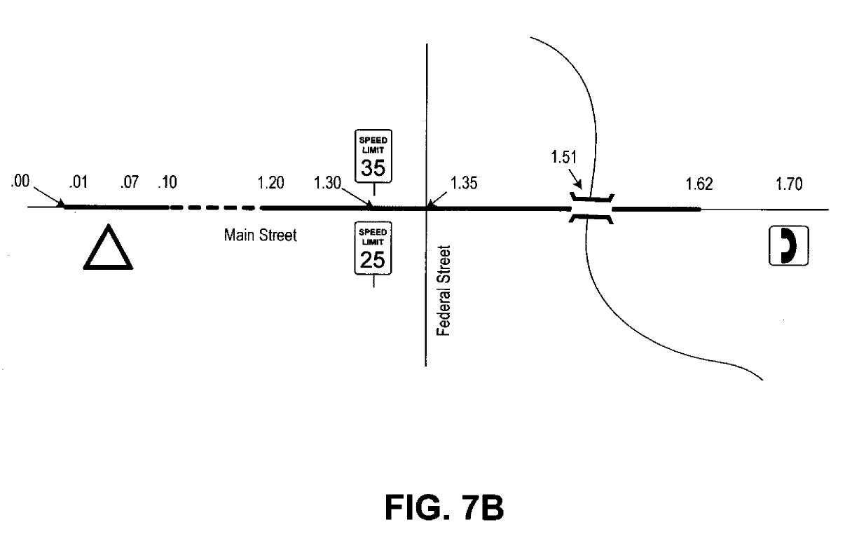

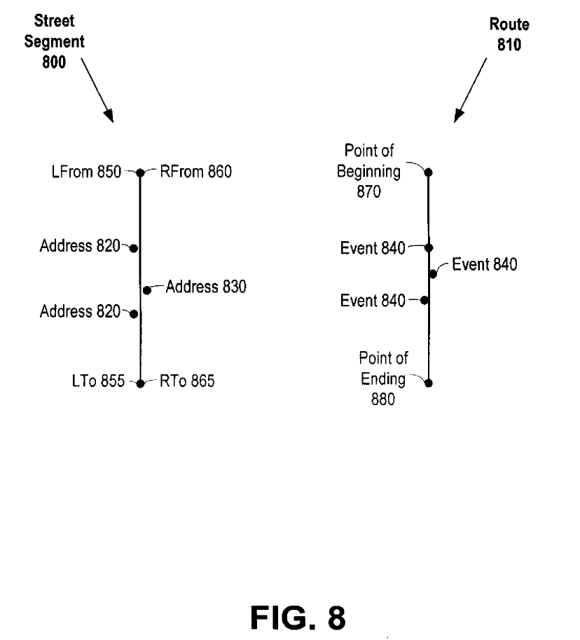

FIG. 8 illustrates an example postal addressing system street segment 800 and an example LRS route 810 that show similarities between the two systems, according to embodiments of the present invention. A postal address 820 and 830 can be thought of as analogous to a LRS event 840. Generally, addresses 820 are located on the left side of the street segment, addresses 830 are located on the right side of the street segment, and LRS events 840 can be located on the route or on either side of the route. The range of postal addresses along a street segment 800, shown by LFrom 850 to LTo 855 on the left side of the street segment or by RFrom 860 to RTo 865 on the right side of the street segment, is analogous to the range of possible events along a LRS route 810, shown by point of beginning 870 to point of ending 880. Furthermore, these similarities can be exploited to the extent that LRS event geocoding can be performed with the same efficiency, accuracy, and system components as postal address geocoding. By doing so, certain problems relating to maintaining DOT LRS event distances in geographic databases can be solved more efficiently than any existing methods. There are clear and significant benefits for doing so, as discussed in more detail below.

Postal address geocoding requires two primary components, which are a database and transformational logic implemented in software. The database contains precisely two combined sets of data, and the transformational logic uses that database to perform the transformation. The two sets of data that are combined to make the postal address geocoding database are an accurate geographic representation of the underlying street network over which the postal addressing system is laid. When properly combined, these two well-defined sets of data are both necessary and sufficient for transforming postal addresses into geographic coordinates. That is, no other data except the postal address to be transformed is required for the transformation process. Only the proper transforming algorithm need be applied.

The sole determining factor for what input data can be transformed by this system is the addressing system set of data. Regardless of whether a postal or LRS system is combined with a street network, the necessary street network data and proper transformational logic would be the same. That is, it is the addressing system, postal or LRS, alone that determines the type of input a geocoding system can successfully transform into a geographic point location.

If a postal addressing system is combined with a geographic representation, postal address geocoding can be performed. Thus, if a LRS is combined with a geographic representation, “event” location geocoding can be performed. The geocoding logic could be made to perform as if a specific postal address is equivalent to a specific LRS “event.” The quality of the geographic data would affect the quality, for example accuracy and uniqueness, of the transformation. The type and form of input data, however, is determined by the addressing system, not the geography. Also, the type and form of output is determined by the geography and algorithm, not the addressing system.

A process is provided for combining a LRS addressing system with a geographic representation of the underlying street network into a new LRS event geocoding database, using the existing process for combining a postal addressing system with the underlying street network. The new LRS event geocoding database is suitable for use with existing geocoding software. Thus, the software logic for postal address transformation can be used unchanged.

The method of identifying events in a LRS is similar in form to the method of identifying events in a postal addressing system database. The LRS event identifier input format is mapped to the postal event identifier form in the following way. Postal addresses are completely identified by the jurisdiction name, postal code, street name, and address number. Each of these components is equated to components of the LRS event identifier. That is, each of postal address components jurisdiction name, postal code, street name, and address number can be equated to LRS event components district, route, control section, and event distance, respectively. Additionally, the postal address component address range after scaling is equivalent to a LRS event distance between route point of beginning and point of ending, as discussed in more detail below.

By scaling the measured distances used for the LRS, initially by 100, discreet “addresses” 0.01 mile apart could be simulated along the LRS route. The resulting DOT LRS address range runs from zero up to the total length of the route. For example, a route 1.70 miles long would contain addresses in the range of 0 to 170. This would provide the fundamental reference for transforming fully qualified DOT LRS event identifiers to geographic coordinates the same way postal address range provides the fundamental link between a postal address and geographic coordinates. This concept is essential to using the same transformational logic as used for postal address geocoding.

For example, an individual street segment in the GIS might have a potential address range from 1 to 99. During postal address geocoding, the addresses in that range are assumed to be evenly distributed along the segment. One end of the street is assumed to be at address 1 and the other is at address 99, and anything that falls in between is interpolated along the street segment. In the case of LRS geocoding, a segment along a route may have one end at a distance 0.15 miles from the point of beginning and the other end at a distance of 0.45 miles from the point of beginning. The range of event addresses along that segment is 15 to 45. Finding the location of events falling within the range can be done by interpolation.

In embodiments, points every linear 0.01 mile along GIS segments comprising the route are used as “potential addresses” in the LRS event geocoding database.

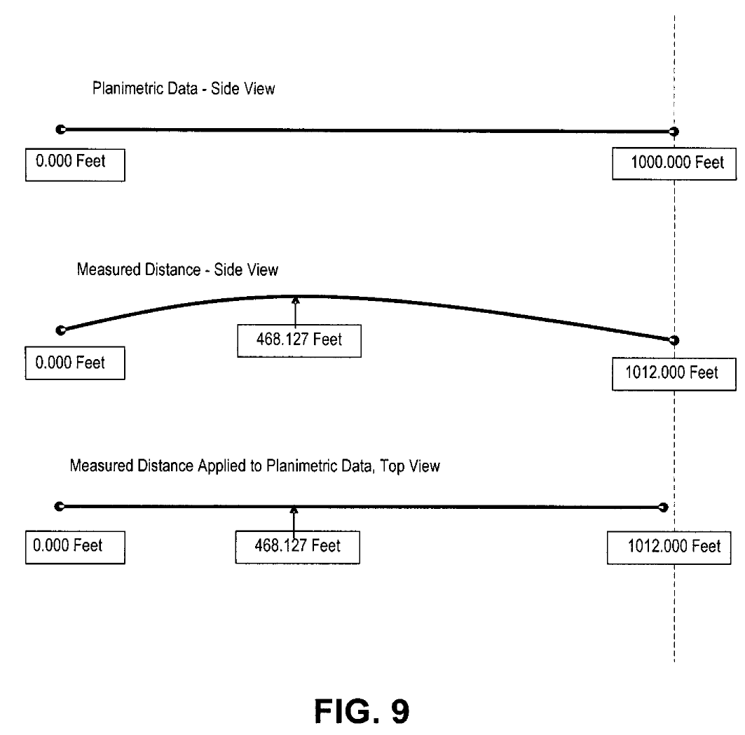

Further, FIG. 9 illustrates potential addresses accounting for roadbed elevation, according to embodiments of the present invention. “Potential addresses” are distributed along the GIS segments, so as to mimic the effects of changes in roadbed elevation on the length of the roadway. The process of LRS geocoding is calibrated. The planimetric data side view shows a two-dimensional road that is one-thousand feet in length. If the third dimension of a route is known, such as elevation, events along the route can be placed more accurately. A roadway's scale changes because the roadway has more distance on a hill than on the flat. Thus, in the measured distance side view shows a three dimensional road that is one-thousand twelve feet, which is longer than the planimetric data side view. This embodiment also takes into consideration the foreshortening effect of the length of the route if elevation is involved, giving a more accurate spatial correlation of the route length and events along the route, as shown in the top view of the road in FIG. 8.

### LRS Event Geocoding Database

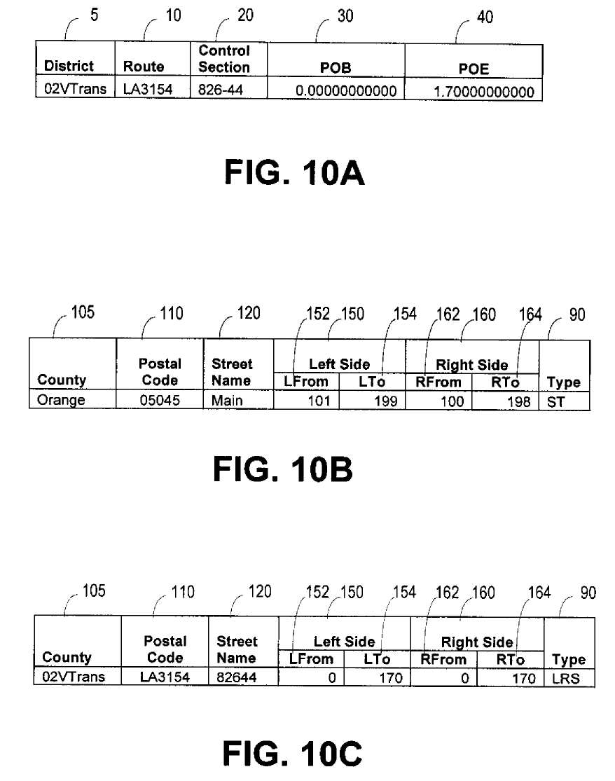

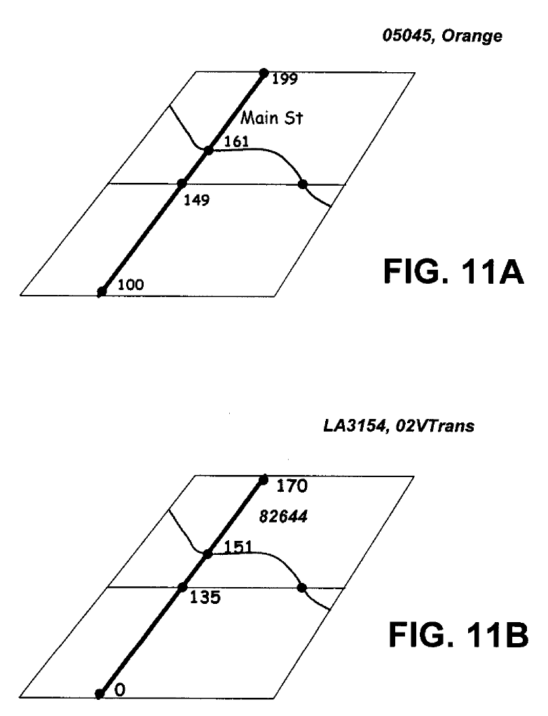

A LRS event geocoding database is created to conform to the requirements of the postal address geocoding software logic. Only the process of forming the LRS data is needed because the existing software logic can use it as if it were postal data. A LRS event geocoding database is another implementation of an address coding guide. The form, content, and processing of the geographic data, that is, aligning range limits to geographic points, is identical for both postal address and LRS event geocoding databases. Starting with only one LRS route definition table entry, as shown in FIG. 10A and discussed below, the explanation can be simplified by showing the content of only one row of each database illustrated, for example, one address range in the postal address geocoding database, and one LRS route in the LRS event geocoding database, as shown in FIGS. 10B-C and discussed below. The address range and LRS route chosen for this example have coincident geography, as shown in FIGS. 11A-B and discussed below. That makes it easier to compare the results of the process in each case, but it is irrelevant to the database building process.

FIG. 10A illustrates an example LRS route definition table entry for the route illustrated in FIG. 7A, according to embodiments of the present invention. The LRS route definitions in FIG. 10A are part of the LRS database. In embodiments, the LRS route definition table is separate from the LRS event table. In embodiments, these two tables or elements of these two tables can be joined into one table. The LRS route definition table is created by the jurisdiction that owns the routes. Measurements of the route lengths are taken by the jurisdiction and included in the table. A set of codes and a style template are also created to ensure that the LRS is consistent with itself and that the symbology is the same. The LRS route definition table acts like a decoder of the map, much like metadata in the GIS. The table contains one row for each route in the LRS. The one-row table entry in the figure illustrates the definition of route LA3154 in route column 10. It is located in district 02VTrans and is further subdivided by the 826-44 control section, as shown in district and control section columns 5 and 20, respectively. It was measured to be exactly 1.70 miles long, as specified by the point of beginning 0.00000000000 and point of ending 1.70000000000, as shown in POB column 30 and POE column 40.

FIG. 10B illustrates an example postal address geocoding table entry, according to embodiments of the present invention. This table entry illustrates how postal data is stored in the postal address geocoding database. The geocoding software interprets this as a declaration that Main St. 120 forms an address range bounded by LFrom 152 and LTo 154 on the Left side 150 of the street and by RFrom 162 and RTo 164 on the Right side 160 of the street. Main St. 120 is in postal code 05045 in Orange county, as shown by columns postal code 110 and county 105, respectively. These columns are the same as those in FIGS. 1 and 4. Although there are two sets of address range columns in FIGS. 1 and 4 for left and rights sides of the street, only one address range is needed for purposes of locating LRS events in FIG. 10B. Geocoding logic would successfully match the address “153 Main St 05045 Orange” to this row and use the geographic data associated with it (not shown) to calculate the location of the address in the geographic database. A type column 90 is also shown to distinguish a postal addressing entry from a LRS event entry in a database should these two types of entries be combined into one database. “ST” in type column 90 is short for “street” and shows that this entry is a postal addressing entry in the postal address geocoding database. Alternatively, these entries could be stored in their own databases without the type column.

FIG. 10C illustrates an example LRS route of FIG. 10A formatted and mapped to the postal address geocoding database format of FIG. 10B, according to the present invention. The LRS route LA3154 in FIG. 10A is mapped and formatted to the postal address geocoding database format in FIG. 10B to construct a LRS event geocoding database. District 5, route 10, and control section 20 of the LRS route are mapped to county 105, postal code 110, and street name 120 of the postal address geocoding database, respectively. Alternatively, other combinations of LRS route elements can be mapped to other combinations of the postal address geocoding database elements.

Additionally, the point of beginning and point of ending of the LRS route are mapped to both LFrom/LTo and to RFrom/RTo of the postal address geocoding database. Alternatively, POB and POE are mapped to one of LFrom/LTo and RFrom/RTo. In this example, possible event distances are one-hundredth mile apart (1.70 miles×100=170 centi-miles). The geocoding software interprets this as a declaration that there are 171 possible event locations, or “addresses,” ranging from 0 to 170 in district 02VTrans, on route LA3154, and in control section 82644, as shown by columns LFrom 152 or RFrom 162, LTo 154 or RTo 164, county 105, postal code 110, and street name 120, respectively. For example, the logic would successfully match the event “43 82644 LA3154 02VTrans” to this row and use the geographic data associated with it (not shown) to calculate the location of the event in the geographic database. “LRS” in type column 90 shows that this entry is a LRS event entry in the postal address geocoding database.

FIG. 11A illustrates an example alignment of postal address data in FIG. 10B with a geographic database, according to embodiments of the present invention. FIG. 11A shows how the address range overlies the corresponding street segments in the geographic database. Using standard practice, the addresses 101, 149, 161, and 199 are aligned with geographic points to provide the necessary calibration for interpolating intermediate address numbers.

FIG. 11B illustrates an example alignment of LRS data in FIG. 10C with a geographic database, according to embodiments of the present invention. FIG. 11B shows how the potential LRS event range, which is a scaled measured distance, is aligned to the same points in the geographic database, providing the calibration for interpolating intermediate event locations, such as events at locations 135 and 151, or 1.35 and 1.51 miles, respectively, from the beginning of route LA3154.

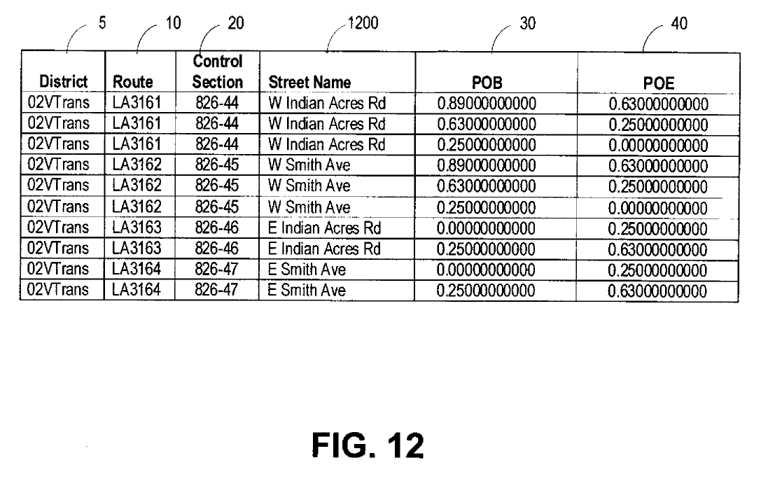

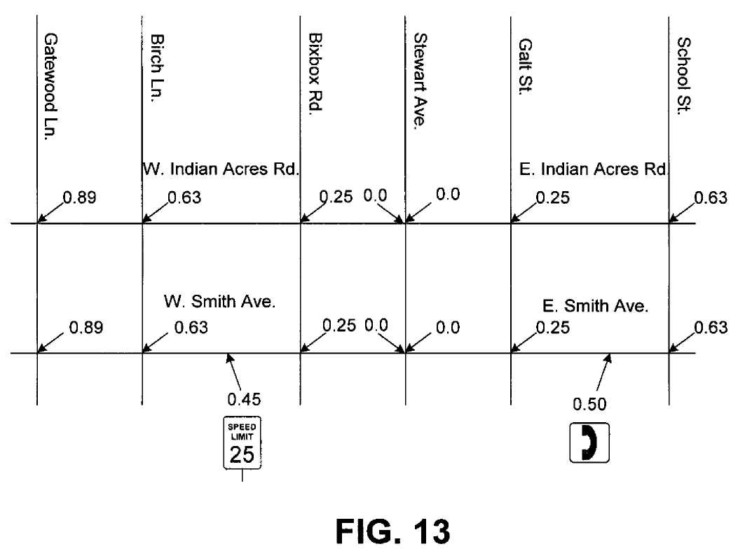

FIG. 12 illustrates an example LRS route definition table for the area identified in the postal addressing system table of FIG. 1, according to embodiments of the present invention. This area is also shown in the maps of FIGS. 2 and 13. For convenience, elements carried over from FIG. 10A are similarly labeled. FIG. 1 contains ten rows, each with a From intersection 130 and a To intersection 140. FIG. 12 also includes ten rows to describe route segments for the same area. For the district 5, shown as 02VTrans, there are four routes 10, shown as LA3161, LA3162, LA3163, and LA3164. The beginning of each of the routes begins at Stewart Ave., going west on W. Indian Acres Rd., going west on W. Smith Ave., going east on E. Indian Acres Rd., and going east on E. Smith Ave., respectively. These street names 1200 are included in this example table. Control section 20 is a subdivision of a route 10, used to allow for events like separate lanes of travel, or bifurcation, and other situations where the route must be subdivided to account for physical reality. In this example, the routes 10 are not subdivided by control sections, so there is one control section 20 for each route 10. The control sections 20 are shown as 826-44, 826-45, 826-46, and 826-47. Each of the ten rows represents a route segment, the length of each route defined by a point of beginning (POB) 30 and a point of ending (POB) 40. For example, in the first row, the route segment with a POB 30 of 0.89000000000 and a POE 40 of 0.63000000000 is on street name 1200 of W. Indian Acres Rd., between Gatewood Ln. and Birch Ln., as shown in FIG. 13, discussed in more detail below.

FIG. 13 illustrates an example map overlaid with information from the LRS route definition table shown in FIG. 12, according to embodiments of the present invention. In addition to being route segment end points, the intersections in this example can also be events. Two additional example events are shown. A speed limit road sign, which indicates a change in speed limit, and corresponds to a speed limit road sign event, is located at a distance of 0.45 miles from Stewart Ave. going west on W. Smith Ave. A call box, corresponding to a call box event, is located at a distance of 0.50 miles from Stewart Ave. going east on E. Smith Ave.

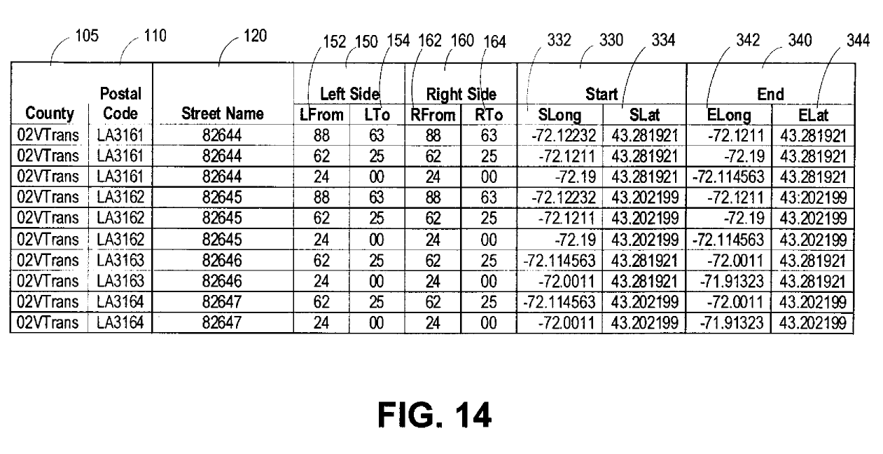

FIG. 14 illustrates example records of a resulting LRS event geocoding database constructed from the example LRS route definition table records illustrated in FIG. 12 and the example GIS database records illustrated in FIG. 3, according to embodiments of the present invention. For convenience, elements carried over from FIGS. 3 and 4, for reasons discussed below, are similarly labeled. The LRS event geocoding database is constructed in a similar manner that the postal address geocoding database of FIG. 4 is constructed from both the example postal addressing system database records illustrated in FIG. 1 and the example GIS database records illustrated in FIG. 3. For FIG. 14, the schema of FIG. 4 is used, but the data is from the LRS route definition table of FIG. 12 instead of the postal addressing system database records of FIG. 1.

Street segment nodes in the GIS database correspond to fixed “addresses” in the LRS just like they correspond to fixed postal addresses. In the case of postal address geocoding, these fixed addresses define the range of addresses along a street segment, for example “1 to 99 on Main Street in 05045.” In the case of LRS events, these fixed “addresses” define the scaled range of events along the route segment, for example, “15 to 45 in control section 826-44 on route LA3161” for a route segment 0.30 miles long. Routes are divided into route segments by physical features, and sometimes the route segment end points correspond to events. Routes are usually segmented, unless a particular route is very short. For example, a route that is a highway will be segmented into route segments by intersecting roads and rivers, among other physical features. The “county,” “postal code,” and “street name” of postal address geocoding can define LRS event districts, routes, and control sections without any punctuation, such as dashes, for example, control section 826-44 can be defined as street name 82644.

The conflation process is used to find rows in FIGS. 12 and 3 that correspond to each other. Although details of the conflation process will not be discussed in more detail here, one part of the conflation process for this example is to find rows in FIGS. 12 and 3 that have the same street name. For example, both FIGS. 12 and 3 contain rows having the street name, W. Indian Acres Rd. In FIG. 3, each row represents a road segment, while in FIG. 12, each row represents a route segment. In embodiments, through a more detailed conflation process that will include such items as identifying cross-street attributes from the more detailed actual GIS database, and not the example GIS database of FIG. 3, the process will find that one row of FIG. 3 will be conflated, or matched, with one row of FIG. 12. A combination of these two rows provides the third row of FIG. 14. For example, the third row of FIG. 3 is on street name 320 of W. Indian Acres Rd., bounded by Bixbox Rd. and Stewart Ave. (not shown in FIG. 3). The conflation process determines that this row corresponds to the third row of FIG. 12, which indicates it, too, is associated with street name 1200 W. Indian Acres Rd., bounded by Bixbox Rd. and Stewart Ave., as shown in FIG. 13. The geometry from FIG. 3, such as latitudes and longitudes of the starting and ending street segment points SLong 332, Slat 334, ELong 342 and ELat 344, are used to populate the third row of FIG. 14.

Once the rows are associated, points of beginning and points of ending can be used to populate the postal address fields of FIG. 14. The conflation process uses the POB 30 and POE 40 of FIG. 12 to determine “address ranges” for FIG. 14. The conflation process converts POBs and POEs by truncating extra zeros from the decimal numbers, and by removing the decimals as well. Because route segments can share end points, the conflation process also subtracts one from either the POB or the POE, whichever is the higher number, to create non-overlapping address ranges. For example, in the first row of FIG. 12, POE 40 of 0.63000000000 becomes 63, and POB 30 of 0.89000000000 becomes 89-1, or 88, because the POB is a higher number than the POE. These numbers, 88 and 63, are used to populate the LFrom 152 and LTo 154, respectively, of the Left side 150 of the street. Entries in the RFrom 162 column and RTo column 164 for the Right side 160 of the street are a copy of the entries for the Left side 150 of the street.

### LRS Event Geocoding Process

Now that the process of building a LRS event geocoding database has been explained, the process for using the LRS event geocoding database to convert a LRS event to a geographic location will be described. The process of transforming the unique combination of route and event distance into the geographic coordinates of the point location is called geocoding. Similarly, the reverse logic can convert a location into a route and event distance by the process of “reverse geocoding.”

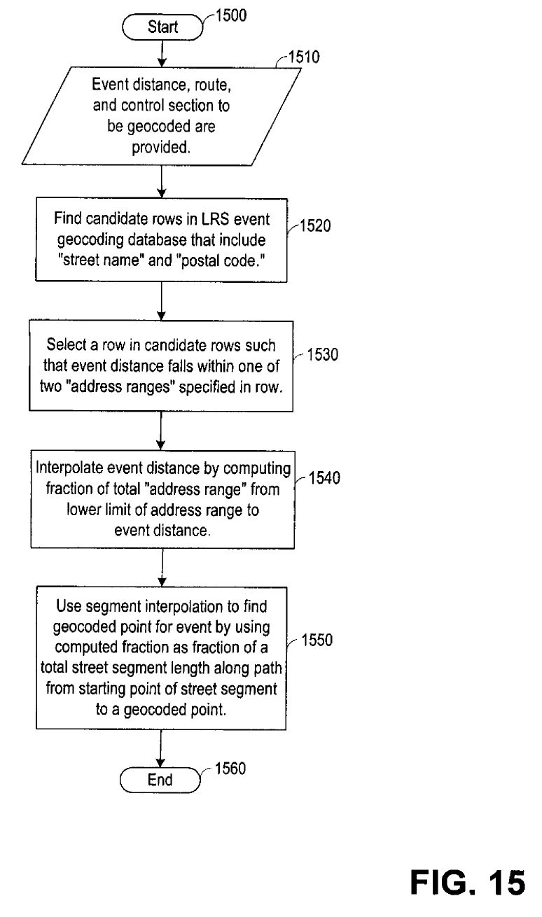

FIG. 15 illustrates an example flowchart of the LRS event geocoding process, according to embodiments of the present invention. Take for example, the LRS callbox event shown on E. Smith Ave. in FIG. 13. The process begins in step 1500. In step 1510, a combination of event distance, control section, and route is provided to the process. This unique combination is the event to be geocoded. These three items are provided in the format of the postal addressing scheme, for example without the decimals and dashes generally included in the LRS database for these items. District and state are generally assumed or may be specified if needed, in order to achieve an unambiguous association between elements. For the callbox event example, suppose that the event distance is 50, the control section is 82647, and the route is LA3164, as found in an LRS event table.

LRS event geocoding may not have many of the same exceptions as postal address geocoding, such as handling even/odd numbering that are assigned differently than the regular plan, handling when features are clustered at one end or other of the segment, applying an appropriate offset to the correct side of the street centerline, handling missing, incorrect, incomplete, or ambiguous address information, dealing with an addressing system that is more chaotic and/or alphanumeric, and rectangular grid systems that have no plan.

The LRS event geocoding may have one of the exceptions, however, which is that interpolating along a winding path from one event to the next must be performed if the path follows any intermediate points, or vertices, that are stored in the geographic representation of the road segment. This point information is contained in geographic datum in the row of the GIS database. Another common exception with LRS geocoding is that interpolating along a winding path from one event to the next will only be as accurate as the geospatial representation of the measured route. Insufficient care in the use of shape points can cause errors when compared to a physically measured route.

In step 1520, the candidate rows in the LRS event geocoding database that include the provided “street name,” or control section, as well as the “postal code,” or route, are found. For the callbox event example, the last two rows of FIG. 14 include the provided control section 82647 and route LA3164. In step 1530, a row in the candidate rows is selected such that the event distance falls within one of the two “address ranges” specified in the row. Either LFrom 152/LTo 154 or RFrom 162/RTo 164 can be used, since these combinations are duplicates of each other and merely round out the entries for the postal addressing schema of the LRS event geocoding database. The route and address ranges in the selected row of the LRS event geocoding database of FIG. 14 came from the LRS database of FIG. 12. For the callbox event example, the second to last row of FIG. 14 includes the address range of 62 to 25, as the provided event distance of 50 falls within the range.

In step 1540, event distance interpolation is performed by computing the fraction of the total “address range” in the selected row of step 1530 that is represented by the amount from the lower limit of the address range to the event distance being geocoded. This step can be performed by the following substeps:

1) subtracting the lower limit of the “address range” from the event distance,

2) subtracting the lower limit of the range from the upper limit of the range, and

3) dividing the result in 1) by the result in 2).

For the callbox event example, 1) subtracting the lower limit of the address range 25 from the event distance of 50 is 25, 2) the difference between the lower limit 25 and upper limit 62 is 37, and 3) 25 divided by 37 is 0.675676. In step 1550, segment interpolation is performed to find a geocoded point for the combination of event distance, control section, and route using the fraction calculated in step 1540. For the street segment specified in the selected row, this fraction is used to find the geocoded point as the fraction in length of the total street segment length along a path from the starting point of the segment to the geocoded point. The street segment and associated starting point in the row of the LRS event geocoding database of FIG. 14 came from the GIS database of FIG. 3. This step can be performed by the following substeps:

1) determining the length of the street segment. This is the length of the path following any intermediate points, or vertices, used to define a windy path, if any. Information about these intermediate points is contained in geographic datum in the row of the database. In the case of the embodiment that takes into account the distortion of hills, the length of the path is appropriately scaled. For example, scaling may not be performed if the input data is less accurate, such as if the input data is in tenths of miles, but scaling may be performed if the input data is survey grade.

2) calculating a distance to the event along the street segment to the event by multiplying the fraction obtained in step 1540 by the length of the street segment obtained in 1).

3) starting at the LFrom or RFrom point of the street segment, measure the distance calculated in 2) along the path joining the start and end points of the street segment.

For the callbox event example, 1) the length of the street segment from FIG. 14, second to last row, is the difference between longitude −72.114563 and longitude −72.0011, which is 0.113463, as the latitude is the same for both end points, 2) the distance to the event is fraction 0.675676 multiplied by length of street segment 0.113463, which is 0.076664, and 3) the distance along the path joining the start and end points of the street segment are −72.0011 plus 0.076664, which is −72.077764 longitude and 43.202199 latitude. This latitude and longitude is the geocoded location of the example callbox event. The process ends in step 1560.

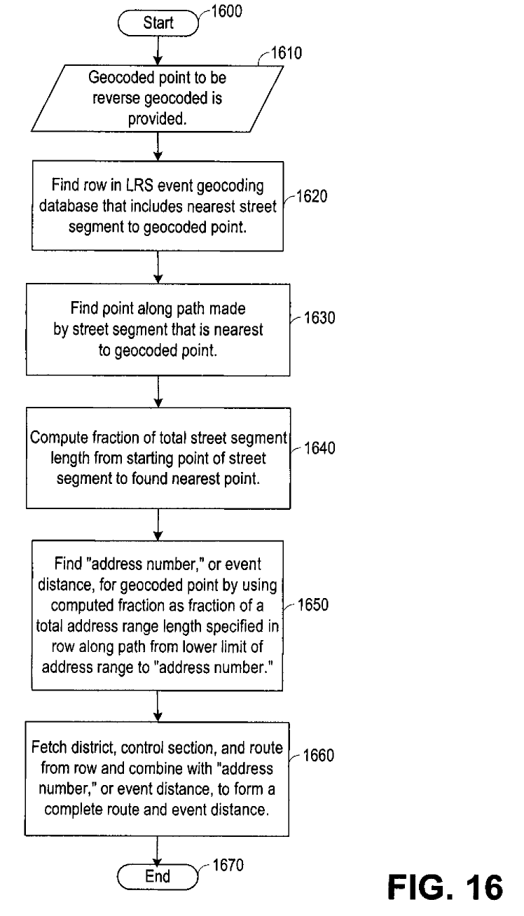

FIG. 16 illustrates an example flowchart of the LRS event reverse geocoding process, according to embodiments of the present invention. Once the LRS event geocoding database and geocoding logic are functioning properly, the same database and the reverse logic can be used to “reverse geocode.” That is, given a geographic location, the nearest route and event distance to that location can be determined. The event corresponding to this nearest route and event distance can be an actual event. The event is a potential event if no actual event is located there, however.

The process begins in step 1600. In step 1610, a geocoded point is provided to the process. This geocoded point will be reverse-geocoded, and is the point for which a route, control section, and event distance will be found. In step 1620, the row that includes the nearest street segment to the geocoded point is found in the LRS event geocoding database. This street segment in the LRS event geocoding database of FIG. 14 came from the GIS database of FIG. 3. In step 1630, the point along the path made by the street segment found in step 1620 that is nearest to the geocoded point is found.

In step 1640, the fraction of the total path length is computed by using the path length from the starting point of the street segment found in step 1620 to the nearest point found in step 1630, divided by the total path length of the street segment. In step 1650, an “address number,” or event distance, corresponding to the geocoded point is found by using the fraction computed in step 1640. For an “address range” specified in the row, this fraction is used to find the address number as a fraction of the total address range from the lower limit of the address range to an address number that will yield this fraction. The “address range” and associated lower limit of the address range in the row of the LRS event geocoding database of FIG. 14 came from the LRS event database of FIG. 12. In step 1660, the district, route, and control section from the row are fetched, and combined with the “address number,” or event distance, found in step 1650 to form the complete route, control section, and event distance. The process ends in step 1670.

A proprietary full-featured LRS event geocoding system contains two basic components: 1) a LRS event database combined with a geographic information system database called a LRS event geocoding database, and 2) a geocoding engine implementing the logic required to look up an address in the LRS event geocoding database and interpolate its geographic location from the information provided by the database. It also provides more advanced capability, such as reverse geocoding.

### System Hardware, Software, and Components

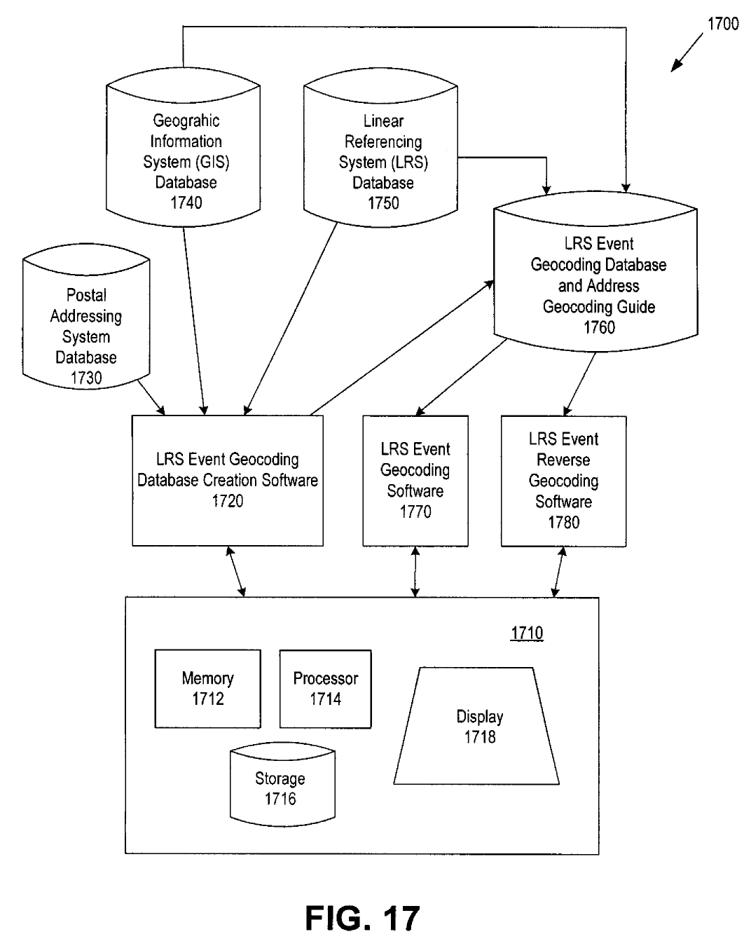

FIG. 17 shows a block diagram of an exemplary system 1700 that can be used with embodiments of the invention. Although this diagram depicts components as logically separate, such depiction is merely for illustrative purposes. It will be apparent to those skilled in the art that the components portrayed in this figure can be combined or divided into separate software, firmware and/or hardware components. Furthermore, it will also be apparent to those skilled in the art that such components, regardless of how they are combined or divided, can execute on the same computing device/system or can be distributed among different computing devices/systems connected by one or more networks or other suitable communication means.

As shown in FIG. 17, the system 1700 typically includes a computing device 1710, which may comprise one or more memories 1712, one or more processors 1714, and one or more storage devices or repositories 1716 of some sort. The system 1700 may further include a display 1718 operating thereon, by which the system can display maps and other information to a user.

As discussed above, LRS event geocoding database creation software 1720 uses schema from the postal addressing system database 1730, schema and data from the GIS database 1740, and data from the LRS database 1750 to create the LRS event geocoding database 1760. Additionally, address coding guide 1760 takes changes from the GIS database 1740 and LRS database 1750 to update the LRS event geocoding database 1760. LRS event geocoding software 1770 uses the LRS event geocoding database 1760 to find the geographic location of an event, given the input of event distance, control section, and route, as discussed above with reference to FIG. 15. LRS event reverse geocoding software 1780 uses the LRS event geocoding database 1760 to find the nearest route and event distance, given the input of a geographic location, as discussed above with reference to FIG. 16.

Computing device 1710 can be any large device, such as a computer or a digitizing table, which a map maker would use, for example, to create the LRS event geocoding database 1760. The computing device 1710 can also be a smaller display device, such as a mobile phone or a personal digital assistant (PDA), which a DOT employee might use out in the field, for example, to find the geographic location of an event using the LRS event geocoding software 1770.

Databases 1730, 1740, 1750, and 1760 are shown as external storage to computing device 1710. However, any number of these databases may be stored together in external storage, and any number of these databases may be stored in storage 1716. The software programs 1720, 1770, and 1780 are used by a user of the computing device 1710. These software programs are shown remote to the user's computing device 1710. However, any number of these software programs may reside together remotely, and any number of these software programs may reside on the user's computing device 1710.

Embodiments of the present invention can include computer-based methods and systems which can be implemented using a conventional general purpose or a specialized digital computer(s) or microprocessor(s), programmed according to the teachings of the present disclosure. Appropriate software coding can readily be prepared by programmers based on the teachings of the present disclosure.

Embodiments of the present invention can include a computer readable medium, such as a computer readable storage medium. The computer readable storage medium can have stored instructions which can be used to program a computer to perform any of the features presented herein. The storage medium can include, but is not limited to, any type of disk including floppy disks, optical discs, DVDs, CD-ROMs, microdrives, and magneto-optical disks, ROMs, RAMs, EPROMs, EEPROMs, DRAMs, flash memory or any media or device suitable for storing instructions and/or data. The present invention can include software for controlling both the hardware of a computer, such as a general purpose/specialized computer(s) or microprocessor(s), and for enabling them to interact with a human user or other mechanism utilizing the results of the present invention. Such software may include, but is not limited to, device drivers, operating systems, execution environments/containers, user interfaces, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting the code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps performed in the embodiments of the invention disclosed can be performed in alternate orders, certain steps can be omitted, and additional steps can be added. It is to be understood that other embodiments of the invention can be developed and fall within the spirit and scope of the invention and claims. The embodiments were chosen and described in order to best explain the principles of the invention and its practical application, thereby enabling others of ordinary skill in the relevant arts to understand the invention for various embodiments and with various modifications that are suited to the particular use contemplated. It is intended that the scope of the invention be defined by the following claims and their equivalents.

What is claimed is:

1. A computer-implemented method for encoding linear referencing system (LRS) events as postal addresses into a geocoding database, the method comprising:
creating a LRS event geocoding database and schema from portions of postal addressing system schema;
encoding LRS data as postal address data, as defined in the postal addressing system; and
attaching the encoded LRS event data with geometric data to populate the LRS event geocoding database.

2. The computer-implemented method of claim 1, wherein encoding comprises generating a postal address range using LRS event distances.

3. The computer-implemented method of claim 2, wherein a postal address range is determined from one of the length of an LRS route and the distance between two LRS events.

4. The computer-implemented method of claim 1, wherein encoding comprises generating street names for LRS event control sections.

5. The computer-implemented method of claim 1, wherein encoding comprises generating postal codes for LRS event routes.

6. The computer-implemented method of claim 1, wherein encoding comprises generating counties for LRS event districts.

7. The computer-implemented method of claim 1, further comprising determining the geographic location of a LRS event using a LRS event identifier as input and the LRS event geocoding database.

8. The computer-implemented method of claim 7, wherein the LRS event identifier comprises event distance, control section, and route.

9. The computer-implemented method of claim 7, further comprising using geocoding software to find the geographic location of the LRS event.

10. The computer-implemented method of claim 1, further comprising determining a LRS event identifier using the geographic location of the LRS event as input and the LRS event geocoding database.

11. The computer-implemented method of claim 10, further comprising using geocoding software to find the LRS event identifier of the LRS event.

12. The computer-implemented method of claim 10, wherein the LRS event identifier comprises event distance, control section, and route.

13. The computer-implemented method of claim 2, further comprising distributing potential addresses along one or more postal address ranges to account for the effect of changes in elevation on the actual length of the associated roadways.

14. The computer-implemented method of claim 2, further comprising foreshortening one or more postal address ranges to account for the effect of changes in elevation on the actual length of the associated roadways.

15. The computer-implemented method of claim 1, wherein the LRS event geocoding database comprises an address coding guide.

16. The computer-implemented method of claim 15, further comprising changing the LRS event geocoding database and address coding guide to reflect one or more of changes in the geographic map, additions to the geographic map, and deletions of elements in the geographic map.

17. The computer-implemented method of claim 15, further comprising changing the LRS event geocoding database and address coding guide to reflect one or more of changes to LRS events, additions of LRS events, and deletions of LRS events.

18. A system for encoding linear referencing system (LRS) events as postal addresses into a geocoding database, the method comprising:
a LRS event geocoding database and schema created from portions of postal addressing system schema;
LRS data encoded as postal address data, as defined in the postal addressing system; and
geometric data attached to the encoded LRS event data to populate the LRS event geocoding database.

19. The system of claim 18, wherein two LRS event distances generate and are encoded as a postal address range.

20. The system of claim 19, wherein a postal address range is determined from one of the length of an LRS route and the distance between two LRS events.

21. The system of claim 18, wherein LRS event control sections are encoded as street names.

22. The system of claim 18, wherein LRS event routes are encoded as postal codes.

23. The system of claim 18, wherein LRS event districts are encoded as counties.

24. The system of claim 18, further comprising a geographic location of a LRS event determined using a LRS event identifier as input and the LRS event geocoding database.

25. The system of claim 24, wherein the LRS event identifier comprises event distance, control section, and route.

26. The system of claim 24, further comprising geocoding software used to find the geographic location of the LRS event.

27. The system of claim 18, further comprising a LRS event identifier determined using the geographic location of the LRS event as input and the LRS event geocoding database.

28. The system of claim 27, further comprising geocoding software used to find the LRS event identifier of the LRS event.

29. The system of claim 27, wherein the LRS event identifier comprises event distance, control section, and route.

30. The system of claim 19, further comprising potential addresses distributed along one or more postal address ranges to account for the effect of changes in elevation on the actual length of the associated roadways.

31. The system of claim 19, further comprising one or more postal address ranges that are foreshortened to account for the effect of changes in elevation on the actual length of the associated roadways.

32. The system of claim 18, wherein the LRS event geocoding database comprises an address coding guide.

33. The system of claim 32, further comprising changes to the LRS event geocoding database and address coding guide to reflect one or more of changes in the geographic map, additions to the geographic map, and deletions of elements in the geographic map.

34. The system of claim 32, further comprising changes to the LRS event geocoding database and address coding guide to reflect one or more of changes to LRS events, additions of LRS events, and deletions of LRS events.

35. A computer readable medium including operations stored thereon that, when processed by one or more processors, causes a system to perform the steps of:
creating a LRS event geocoding database and schema from portions of postal addressing system schema;
encoding LRS data as postal address data, as defined in the postal addressing system; and
attaching the encoded LRS event data with geometric data to populate the LRS event geocoding database.
